(19) United States
(12) Patent Application Publication
(10) Pub. No.: US 2004/0257364 A1
(43) Pub. Date: Dec. 23, 2004

(54) Shadow casting within a virtual three-dimensional terrain model

(76) Inventor: Gregory A. Basler, St. Charles, MO (US)

Correspondence Address: THOMPSON COBURN, LLP, ONE US BANK PLAZA, SUITE 3500, ST LOUIS, MO, 63101, US

(21) Appl. No.: 10/464,042

(22) Filed: Jun. 18, 2003

(51) Int. Cl. G06T 15/60

(52) U.S. Cl. 345/426

(57) ABSTRACT

A method is disclosed for the rendering of shadows in a virtual three-dimensional terrain model. In the preferred method of practicing the invention, shadows cast by a given light source are determined using the highest level of detail (LOD) set of surfaces that represent the virtual terrain and using a ray-tracing technique performed on individual texels of such surfaces. These shadow definitions are used to create shadow rendering on lower LOD sets of surfaces in a manner such that the lower LOD surfaces are rendered with shadows having a higher LOD than would otherwise be obtained using a ray-tracing technique performed on the lower LOD surfaces.

### BACKGROUND OF THE INVENTION

The present invention pertains to methods of generating theoretical shadows within virtual three-dimensional terrain models. The theoretical shadows are used to render the virtual three-dimension terrain in a manner reflecting shadow conditions that theoretically would exist based on a given light situation and based on the geometry of the virtual terrain.

The present invention pertains particularly to rendering shadows in connection with flight simulation software for use in actual flight training or mission briefings. A primary aspect of such flight simulation involves the rendering of virtual three-dimensional environments in real-time. In low level flight simulations, such rendering includes the rendering of the virtual three dimensional terrain associated with the virtual environment. The rendering of shadows that are theoretically cast on such virtual terrain is an important aspect of the overall rendering of the environment because such shadows in real-life situations offer pilots and weapons operators visual cues of hazards, landmarks, structures, vehicles, targets, and of the contour of the terrain. Additionally, shadows are known to increase depth perception.

The theoretical contour of a virtual terrain is often interpolated from satellite imagery of an actual real-life terrain. The rendering of the virtual terrain in a simulator typically comprises the creation of a set of virtual surfaces that collectively represent the theoretical terrain. The larger the number of surfaces that are used to represent the theoretical terrain, or the more complex such surfaces are, the more accurately the surfaces represent the theoretical terrain. However, increasing the complexity or number of surfaces used to render the terrain in real-time requires a corresponding increase of computational power devoted to such rendering during the running of a simulation. For this reason, several sets of surfaces are often created that each represent the theoretical terrain, with the number of surfaces or surface complexity varying from set to set. Thus, several sets of surfaces are created with varying levels of detail or accuracy to the virtual terrain being modeled. The rendering process typically uses a combination of some of the surfaces of each of the sets of surfaces to create as accurate a rendering as possible given the computational power available to the rendering process. Generally, the highest level detail surfaces are used to render the theoretical foreground of the virtual terrain and lower level of detail surfaces are used to render the theoretically more distant terrain.

The rendering of a virtual terrain typically comprises texture mapping one or more texture maps to texels associated with each of the surfaces and then transposing the color information of the texels to pixel color information for two-dimensional display on a monitor or the like. The more theoretically distant a displayed surface is, the less pixels are used to render the surface. Thus, the texel density of the lower level of detail surfaces, which make up the more distant surfaces displayed, can generally be less than the texel density of the higher level of detail surfaces without affecting the accuracy of the rendering. As such, lower resolution texture maps are often used to texture map the lower level of detail surfaces.

The rendering of shadows cast on the virtual terrain for any given light source if often generated on-the-fly using a ray-tracing technique that is dependent on the virtual geometry of the surfaces being rendered. This may result in mix of more or less accurately rendered shadows based on whether a higher or lower level of detail surface is theoretically casting each particular shadow. Additionally, shadows rendered using such methods may appear choppy during a simulation due to the fact that, as portions of the virtual terrain move between the background and foreground, the surfaces casting such shadows may switch between different levels of detail with such virtual movement. Yet further, ray-tracing on-the-fly consumes appreciable computational power that could otherwise be utilized by other software routines.

### SUMMARY OF THE INVENTION

The present invention provides for the rendering of shadows in a virtual three-dimensional terrain model in an efficient manner, despite such shadows being at a high level detail. The preferred method of practicing the invention is particularly adapted for use in rendering virtual three-dimensional terrain models that are based on satellite images and that are used in military flight simulators. In the preferred method of practicing the invention, shadows cast by a given light source are determined using the highest level of detail (LOD) set of surfaces that represent the virtual terrain and using a ray-tracing technique performed on individual texels of such surfaces. These shadow definitions are used to create a shadow map that is then used to create shadow rendering on lower LOD sets of surfaces. Thus the lower LOD surfaces can be rendered with shadows having a higher LOD than would otherwise be obtained using a ray-tracing technique performed on the lower LOD surfaces. Moreover, the texture maps used to render the surfaces are altered to include the shadows and therefore the rendering of the shadows during use of the database does not require on-the-fly ray-tracing.

In a first aspect of the invention a method of rendering shadows in a virtual three-dimensional terrain model comprises the step of creating a plurality of planar surface polygons in virtual three-dimensional space that collectively represent the virtual three-dimensional terrain. Each of the surface polygons has a face direction that is defined as being directed away from the terrain and perpendicular to the respective surface polygon. The method further comprises associating a set of texels with each of the surface polygons. Each of the texels has hue, lightness, and saturation values associated therewith and each also has a light source direction vector defined as a vector in the three-dimensional space that extends away from a virtual light source and that intersects the respective texel. Additionally, the method comprises identifying a first one of the surface polygons whose face direction is greater than ninety degrees from the light source direction vector of each of the texels associated with the first polygon (i.e., the first surface polygon faces toward the light source). Yet further, the method comprises identifying a second one of the surface polygons whose face direction is less than ninety degrees from the light source direction vector of each of the texels associated with the second polygon (i.e., the second surface polygon faces away from the light source). The second surface polygon is positioned between the virtual light source and the first surface polygon and intersects the light source direction vector of at least a first texel of the set of texels associated with the first surface polygon. Further still, the method comprises modifying one of the hue, lightness, and saturation values of the first texel in response to the second surface polygon intersecting the light source direction vector of the first texel.

In another aspect of the invention, a method of rendering shadows in a virtual three-dimensional terrain model comprises creating a first set of surfaces in virtual three-dimensional space that collectively represent the virtual three-dimensional terrain and creating a second set of surfaces in the virtual three-dimensional space that also collectively represent the virtual three-dimensional terrain. The second set of surfaces are less dense than the first set of surfaces and thereby representing a lower level of detail of the virtual three-dimensional terrain. The method also comprises utilizing a ray-tracing technique to determine shadows cast by some of the surfaces of the first set onto other of the surfaces of the first set. Yet further, the method comprises utilizing the determined shadows cast to render shadows on at least some of the second set of surfaces. As such, the rendered shadows on the second set of surfaces are dependant on the geometry of the first set of surfaces and thereby have greater detail than if based solely on the geometry of the second set of surfaces.

In yet another aspect of the invention, a method of rendering shadows in a virtual three-dimensional terrain model comprises creating a first set of surfaces in virtual three-dimensional space that collectively represent the virtual three-dimensional terrain. Additionally, the method comprises associating a first texture map, comprised of a plurality of texels, with a first portion of the virtual three-dimensional terrain. The method further comprises creating a shadow map containing information indicative of whether or not each of the texels of the first texture map would be shadowed for a given theoretical light situation based upon the geometry of the first set of surfaces. Yet further, the method comprises associating a second texture map, comprised of a plurality of texels, with a second portion of the virtual three-dimensional terrain and identifying an overlap region of the virtual three-dimensional terrain that is part of both the first and second portions of the virtual three-dimensional terrain. Additionally, the method comprises correlating at least some of the texels of the first texture map associated with the overlap region with at least some of the texels of the second texture map associated with the overlap region. Still further, the method comprises determining which of each of the correlated texels of the second texture map would be shadowed for the given light situation based on whether the information of the shadow map indicates that the correlated texels of the first texture map would be shadowed for the given light situation.

While the principal advantages and features of the invention have been described above, additional features and advantages may be obtained by referring to the drawings and the detailed description of the preferred embodiment, which follow.

### BRIEF DESCRIPTION OF THE DRAWINGS

FIG. 1 is a flowchart of the generation of the shadow maps for the highest LOD surfaces performed using the preferred method of practicing the invention.

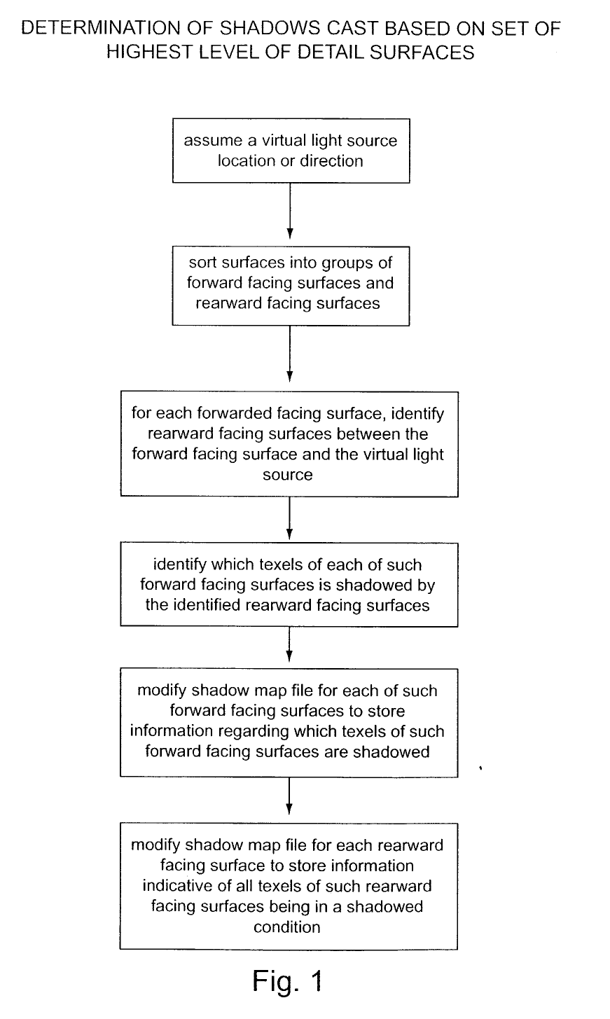

FIG. 2 is a flowchart of the migration of the shadows generated from the highest LOD surfaces to the lower LOD texture maps and lower LOD surfaces.

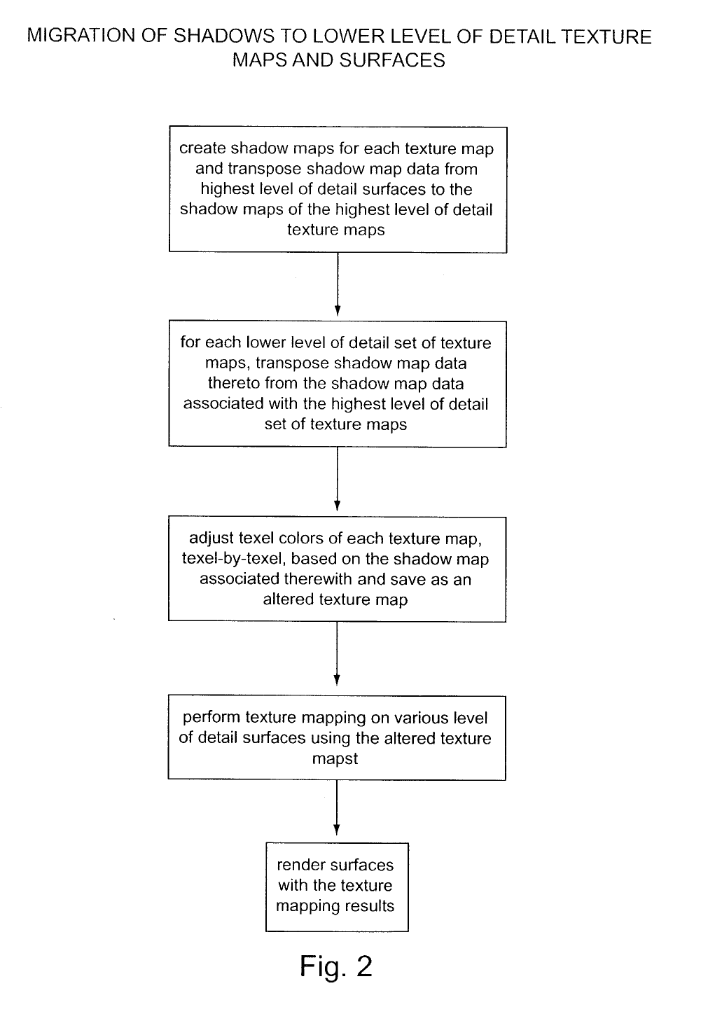

### DETAILED DESCRIPTION OF THE PREFERRED METHOD OF PRACTICING THE INVENTION

As mentioned above, the preferred method of practicing the invention is utilized to render shadows on virtual three-dimensional terrain models for use in highly sophisticated military flight simulators. Typically, the virtual terrain being modeled is interpolated from satellite images of actual geographic terrain, including man made structures or objects.

Using methods well know in the art, the virtual three-dimensional terrain is generated from the satellite images. However, it should be appreciated that the virtual terrain could be created by any other means and could be entirely contrived. Regardless, to render this virtual terrain, a number of surfaces are created in virtual three-dimensional space that collectively represent the virtual terrain. As discussed above, in general, the greater the number of surfaces used to render a particular portion of the virtual terrain, the greater the LOD or accuracy of the rendered surfaces to the theoretical contour of the virtual terrain, and hence to the actual geographic terrain.

During a flight simulation or other rendering of the virtual terrain, the terrain is typically rendered in two-dimensional format and those objects or surfaces that are theoretically closest to the view of the pilot or other person are rendered larger than other, theoretically more distant, surfaces. The most distant surfaces rendered may be represented by only a single pixel, while a single close surfaces may each be rendered by a large numbers of pixels. For this reason, the preferred method of practicing the invention combines the use of lower LOD surfaces with higher LOD surfaces during rendering to free computer processing capabilities that otherwise would be wasted. Thus, various sets of surfaces representing the virtual terrain are created with lower LOD sets having fewer and fewer number of surfaces. Using techniques well know in the art, the preferred method of practicing the invention determines whether a particular portion of the terrain, at any particular time, should be rendered using surfaces from a high LOD set or using surfaces from a lower LOD set.

In addition to utilizing different LOD sets of surfaces to render the virtual terrain, the preferred method of practicing the invention also utilizes different detail levels of texture maps for the same reasons. It should be appreciated that in the preferred method of practicing the invention, the rendering of a surface is performed by texture mapping at least one texture map to the texels assigned to the surface and then rendering those texels as one or more pixels on a computer monitor or the like. Because distant surfaces are rendered generally with fewer pixels, the texel density of lower LOD surfaces are lower than that of higher LOD surfaces. This allows for faster rendering or for reduced computational burden during rendering, without reducing the appearance of the rendering.

In view of the above, the preferred method of practicing the invention utilizes a database comprising a high LOD set of surfaces that collectively represent the virtual terrain, at least one lower LOD set of surfaces that collectively represent the virtual terrain, one or more high LOD texture maps representative of the texture of the virtual terrain, and one or more lower LOD texture maps representative of the texture of the virtual terrain. The surfaces are preferably planer surface polygons but could also be more complex three-dimensional surfaces. Important aspects of the preferred method of practicing the invention pertain to the determination of the theoretical shadows cast on the surfaces and to the storage of such shadow information.

The determination of shadows cast on the surfaces begins by determining a theoretical light source location or direction within the three-dimensional space relative to the virtual terrain. For distant light sources, such as moonlight, the light source may be assumed to be infinitely far away such that light theoretically striking any portion of the terrain is assumed to emanate from the same directional vector as it does from any other portion of the terrain. Alternatively, for point light sources, a light direction vector can be defined for any particular location on the virtual terrain as a vector extending from the light source to the location on the virtual terrain.

Having determined the light source vectors, each surface of the set of high LOD surfaces is sorted into a group of either forward facing surfaces or rearward facing surfaces. The forward facing surfaces are those that theoretically face toward the light source, or in other words face greater than ninety degrees from the light source direction vector. Similarly, the rearward facing surfaces are those surfaces that theoretically face away from the light source, i.e., less than ninety degrees from the light source direction vector. Once this has been performed, each front facing surface is checked against each rearward facing surface to determine whether any part of the rearward facing surface lies between any part of the forward facing surface and the light source, or whether any portion of the rearward facing surface intersects the light source direction vector of any part or texel of the forward facing surface. If such is the case, each texel of the forward facing surface is checked to determine whether or not the light source direction vector associated with the texel is intersected by the rearward facing surface. A “shadow map” is also created for the forward facing surface to store the data indicative of whether or not the light source direction vector associated with each texel is intersected by the rearward facing surface. To this end, the shadow map can be simply a file having a single bit of data for each texel of the surface. After this procedure has been completed for each forward facing surface, the data in the shadow maps associated with each of the rearward facing polygons is modified to indicate that each texel of each rearward facing surface should also be represented as being shadowed.

Having performed the above mentioned steps of determining the shadows cast on the set of high LOD surfaces, the preferred method of practicing the invention then performs a migration routine to create shadow maps for the other lower LOD sets of surfaces. In the preferred method, a set of high LOD texture maps collectively are used to texture map the high LOD set of surfaces and other sets of lower LOD texture maps are used to texture map the lower LOD sets of surfaces. Each set of texture maps essentially represents a two-dimensional projection of the desired texture of the virtual terrain. In other words, a set of texture maps is like a set of two-dimensional aerial photographs of the texture of the virtual terrain. These texture maps are texture mapped to the surfaces using well know texture mapping techniques. Using a method similar to texture mapping, but in reverse, the shadow map of each surface of the high LOD set of surfaces is transposed to a shadow map that is created for each of the high LOD texture maps. The shadow map created for each texture map is preferably simply a file having a single bit of data for each texel of the texture map, with each bit being indicative of whether or not the texel is to be shaded. It should be appreciated that this transposition can be done using the correlation between the texels of each texture map with the texels of the surfaces as determined using the convention texture mapping techniques.

The next step performed in the migration routine is to transpose the data of the shadow maps of the set of high LOD texture maps to shadow maps created for each of the sets of lower LOD texture maps. In the preferred method of practicing the invention, there is not a direct one-to-one correlation between each texture map of the set of high LOD texture maps and each texture map of the sets of lower LOD texture maps. Thus, there is an overlapping correlation and it is necessary to correlate texels of the high LOD texture maps to texels in each set of lower LOD texture maps based upon the proximity of the portions of the virtual terrain that such texels are mapped to. In other words, the method effectively overlays the texture maps and then identifies correlating texels based on their proximity to each other. Having done this, the data in the shadow maps for the set of high LOD texture maps is transposed to the shadow maps created for each set of lower LOD texture maps based upon the above-mentioned correlation between the texels associated therewith.

Having performed the above-mentioned steps, each set of texture maps can be altered or saved to new texture map files in a manner representing shadowed texture maps. During the step of altering the texture maps, each shadow map is utilized to determine which pixels in its associated texture map should be shaded. For each texel that should be shaded at least one of the hue, saturation, or lightness values originally associated with the texel is modified in a manner indicative of being a shadowed version of its original color. It should be appreciated that each texel of each texture map originally has a color associated therewith. Such colors include black, white, and shades of gray and any such color can generally be said to have hue, saturation, and lightness values associated therewith. It should also be appreciated that such color values may be stored in various forms, such as red-blue-green, but nonetheless could be converted from one form to another. Thus, regardless of the format in which a color is stored, modifying the color alters at least one of the color's hue, saturation, and lightness values.

The altered texture maps are then used in place of the original texture maps and are texture mapped to the appropriate surfaces. Thus, when rendering the texture mapped surfaces, such surfaces will appear to have shadows cast thereon. More importantly, it should be appreciated that, because the shadow maps are based on shadows determined by ray-tracing the high LOD surfaces, even the shadows rendered on the lower LOD surfaces will have borders resembling those of the shadows associated with the set of higher LOD surfaces. In other words, the shadows rendered on the lower LOD surfaces more accurately reflect the theoretically correct shadows than they would if such shadows were determined by ray-tracing the lower LOD surfaces.

It should also be appreciated that, by altering the actual texture maps used to texture map the surfaces, shadows can be rendered during the running of a flight simulator or other program without ray-tracing on-the-fly. This frees the computational power otherwise required to perform such ray-tracing, thereby leaving more computational power for other purposes.

Although the invention has been described by reference to a preferred method of its practice, it should be understood that all matter contained in the above description or shown in the accompanying figures is intended to be interpreted as illustrative and not in a limiting sense and that various modifications of the preferred method and aspects thereof may be employed without departing from the scope of the invention defined by the following claims. For example, it should be appreciated that, although the preferred method of practicing the invention is directed to rendering shadows based upon a single virtual light source, the ray-tracing steps of the method could just as easily employed to determine theoretical shadows cast by multiple virtual light sources. As another example, texels of surfaces in a particular LOD set could be correlated directly with texels of surfaces in other LOD sets, without necessarily correlating such texels through texture maps. Thus, other possible variations and modifications of method in accordance with the invention should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, to the extent the term “portion” is used in the claims or is added by amendment, such term should be construed as meaning some or all of the item or element that it qualifies.

What is claimed is:

1. A method of rendering shadows in a virtual three-dimensional terrain model comprising:
creating a plurality of planar surface polygons in virtual three-dimensional space that collectively represent the virtual three-dimensional terrain, each of the surface polygons having a face direction that is defined as being directed away from the terrain and perpendicular to the respective surface polygon;
associating a set of texels with each of the surface polygons, each of the texels having hue, lightness, and saturation values associated therewith, each of the texels also having a light source direction vector defined as a vector in the three-dimensional space that extends away from a virtual light source and that intersects the respective texel;
identifying a first one of the surface polygons, the face direction of the first surface polygon being greater than ninety degrees from the light source direction vector of each of the texels of the set texels associated with the first polygon, the first surface polygon thereby facing the light source;
identifying a second one of the surface polygons, the face direction of the second surface polygon being less than ninety degrees from the light source direction vector of each of the texels of the set texels associated with the second polygon, the second surface polygon also being positioned between the virtual light source and the first surface polygon and intersecting the light source direction vector of a first texel of the set of texels associated with the first surface polygon; and
modifying one of the hue, lightness, and saturation values of the first texel in response to the second surface polygon intersecting the light source direction vector of the first texel.

2. A method in accordance with claim 1 wherein the method further comprises steps of:
dividing the plurality of surface polygons into a set of forward facing surface polygons and a set of rearward facing polygons, the face direction of each surface polygon of the set of forward facing surface polygons being greater than ninety degrees from the light source direction vector of each of the texels of the set texels associated therewith, the face direction of each surface polygon of the set of rearward facing surface polygons being less than ninety degrees from the light source direction vector of each of the texels of the set texels associated therewith; and
checking each of the surface polygons in the set of rearward facing surface polygons to determine whether any of the light source direction vectors of the set of texels associated with the first surface polygon intersects the respective reward facing surface polygon.

3. A method in accordance with claim 1 further comprising making an assumption that the light source is infinitely distant from the virtual three-dimensional terrain such that the light source direction vectors of each of the texels of each of the surface polygons are parallel to each other.

4. A method in accordance with claim 1 wherein the plurality of surface polygons constitute a first set of surface polygons and wherein the method further comprises steps of:
creating a second set of planar surface polygons in virtual three-dimensional space that collectively represent the virtual three-dimensional terrain, the second set of surface polygons being less dense than the first set of surface polygons and thereby representing a lower level of detail of the virtual three-dimensional terrain;
associating a set of texels with each of the second set of surface polygons, each of the texels associated with the second set of surface polygons having hue, lightness, and saturation values associated therewith; and
modifying one of the hue, lightness, and saturation values of at least one of the texels of the second set of surface polygons in response to the modification of one of the hue, lightness, and saturation values of the first texel of the first surface polygon of the first set of surface polygons.

5. A method of using a satellite image to create a shadowed three-dimensional virtual terrain model, the method comprising:
using the satellite image to create a virtual three-dimensional terrain model and to create a two-dimensional texture map, the two-dimensional texture map comprising a plurality of texels that are each have hue, lightness, and saturation values; and
rendering shadows in the virtual three-dimensional terrain model in accordance with claim 1, the hue, lightness, and saturation values of the first texel being dependent upon the hue, lightness, and saturation values of at least one of the texels of the two-dimensional texture map.

6. A method of creating flight-simulator software comprising:
using a satellite image to create a shadowed three-dimensional virtual terrain model in accordance with claim 5.

7. A method of rendering shadows in a virtual three-dimensional terrain model comprising:
creating a first set of surfaces in virtual three-dimensional space that collectively represent the virtual three-dimensional terrain;
creating a second set of surfaces in the virtual three-dimensional space that collectively represent the virtual three-dimensional terrain, the second set of surfaces being less dense than the first set of surfaces and thereby representing a lower level of detail of the virtual three-dimensional terrain;
utilizing a ray-tracing technique to determine shadows cast by some of the surfaces of the first set onto other of the surfaces of the first set; and
utilizing the determined shadows cast to render shadows on at least some of the second set of surfaces.

8. A method in accordance with claim 7 wherein each of the surfaces of the first set of surfaces is a planer polygon and wherein the step of utilizing the ray-tracing technique to determine shadows cast by some of the surfaces of the first set onto other of the surfaces of the first set comprises:
assigning a face direction to each of the surface of the first set of surfaces, the face direction being directed away from the terrain and perpendicular to the respective surface;
associating a set of texels with each of the surfaces of the first set of surfaces, each of the texels having a light source direction vector defined as a vector in the three-dimensional space that extends away from a virtual light source and that intersects the respective texel;
identifying a first one of the surfaces of the first set of surfaces, the face direction of the first surface being greater than ninety degrees from the light source direction vector of each of the texels of the set texels associated with the first surface, the first surface thereby facing the light source;
identifying a second one of the surfaces of the first set of surfaces, the face direction of the second surface being less than ninety degrees from the light source direction vector of each of the texels of the set texels associated with the second surface, the second surface also being positioned between the virtual light source and the first surface and intersecting the light source direction vector of a first texel of the set of texels associated with the first surface; and
determining whether the direction vector of each texel of the first surface is intersected by the second surface.

9. A method of using a satellite image to create a shadowed three dimensional virtual terrain model, the method comprising:
using the satellite image to create a virtual three-dimensional terrain model; and
rendering shadows in the virtual three-dimensional terrain model in accordance with claim 7.

10. A method of creating flight-simulator software comprising:
using a satellite image to create a shadowed three-dimensional virtual terrain model in accordance with claim 9.

11. A method of rendering shadows in a virtual three-dimensional terrain model comprising;
creating a first set of surfaces in virtual three-dimensional space that collectively represent the virtual three-dimensional terrain;
associating a first texture map with a first portion of the virtual three-dimensional terrain, the first texture map comprising a plurality of texels;
creating a shadow map containing information indicative of whether or not each of the texels of the first texture map would be shadowed for a given theoretical light situation based upon the geometry of the first set of surfaces;
associating a second texture map with a second portion of the virtual three-dimensional terrain, the second texture map comprising a plurality of texels;
identifying an overlap region of the virtual three-dimensional terrain that is part of both the first and second portions of the virtual three-dimensional terrain;
correlating at least some of the texels of the first texture map associated with the overlap region of the virtual three-dimensional terrain with at least some of the texels of the second texture map associated with the overlap region;
determining which of each of the correlated texels of the second texture map would be shadowed for the given light situation based on whether the information of the shadow map indicates that the correlated texels of the first texture map would be shadowed for the given light situation.

12. A method in accordance with claim 11 further comprising:
creating a second set of surfaces in the virtual three-dimensional space that collectively represent the virtual three-dimensional terrain, the second set of surfaces being less dense than the first set of surfaces and thereby representing a lower level of detail of the virtual three-dimensional terrain; and
texture mapping the second texture map onto at least a some of the second set of surfaces.

13. A method in accordance with claim 11 wherein each of the surfaces of the first set of surfaces is a planer polygon and wherein the step of creating a shadow map containing information indicative of whether or not each of the texels of the first texture map would be shadowed for the given theoretical light situation comprises:
assigning a face direction to each of the surface of the first set of surfaces, the face direction being directed away from the terrain and perpendicular to the respective surface;
associating a set of texels with each of the surfaces of the first set of surfaces, each of the texels having a light source direction vector defined as a vector in the three-dimensional space that extends away from a virtual light source and that intersects the respective texel;
identifying a first one of the surfaces of the first set of surfaces, the face direction of the first surface being greater than ninety degrees from the light source direction vector of each of the texels of the set texels associated with the first surface, the first surface thereby facing the light source;
identifying a second one of the surfaces of the first set of surfaces, the face direction of the second surface being less than ninety degrees from the light source direction vector of each of the texels of the set texels associated with the second surface, the second surface also being positioned between the virtual light source and the first surface and intersecting the light source direction vector of a first texel of the set of texels associated with the first surface; and
determining whether the direction vector of each texel of the first surface is intersected by the second surface.

14. A method of using a satellite image to create a shadowed three-dimensional virtual terrain model, the method comprising:
using the satellite image to create a virtual three-dimensional terrain model; and
rendering shadows in the virtual three-dimensional terrain model in accordance with claim 11.

15. A method in accordance with claim 14 further comprising assigning hue, lightness, and saturation values to each of the texels of the first and second texture maps based on the satellite image.

16. A method of creating flight-simulator software comprising:
using a satellite image to create a shadowed three-dimensional virtual terrain model in accordance with claim 14.
